(19) United States
(12) Patent Application Publication
(10) Pub. No.: US 2011/0108495 A1
(43) Pub. Date: May 12, 2011

(54) Specimen Analysis and Extraction System

(75) Inventors: Matthew Neil Mynott Taylor, Auckland (NZ); Brian Paul Mynott Taylor, Hamilton (NZ)

(73) Assignee: Matthew Neil Mynott Taylor, Hamilton (NZ)

(21) Appl. No.: 12/613,934

(22) Filed: Nov. 6, 2009

(51) Int. Cl. B01D 37/04; B01D 37/00

(52) U.S. Cl. 210/776; 210/797; 210/767; 210/800; 222/1

(57) ABSTRACT

The invention relates to the process of automating a laboratory process for analysing the chemical properties of powder. The functions that have been automated are the scooping of an accurate volume of powder into beakers, adding an accurate volume chemical solution, agitating for a predetermined time, settling, withdrawal of the chemical solution, emptying, cleaning and rinsing of the beakers, filtering, and filling test tube racks ready for analysis, online measurement of pH, measuring weight of powder, and dosing dry powder into vessels for traditional analysis.

### BACKGROUND OF THE INVENTION

This invention relates to the process of automating and existing laboratory process to allow analysis of powder (pulverised dried earth). The process historically involves many types of tests that look for different elements contained in the powder, and is typically extremely repetitious. Any one test usually involves scooping the powder into a beaker, adding a volume of reagent, agitating for a time, filtering through filter paper cones, and collecting in test tubes, and presenting for analysis.

Some productivity enhancement techniques are used; for example, agitating many beakers simultaneously, bar coding samples, filtering many samples simultaneously etc; but there is still a high manual content. For example: devices exist for agitating beakers—but they still need to be loaded and unloaded, and the agitator turned on and off. Similarly multiple beakers can be filtered simultaneously, but filter papers still need to be folded, put in place, and then the sample poured, filter paper removed, and then all of the equipment needs to be washed before reused.

The main reasons for wanting to automate this process are to increase operator productivity (reduce labor costs), reduce transcription errors (where customers gets the wrong result), and defer capital expense usually associated with increased production.

To allow automation the invention is described. Any powder that requires chemical analysis can be scooped in this manner. The preferred embodiment of the invention requires the powder to be in open topped containers, the containers are arranged inside racks and the racks are located on a table. The scooper picks up the containers it moves to a position above a beaker, and doses a volume of powder. The scooper does this once for each test required and then returns them to their initial position. A chemical solution is then dosed to each beaker, the beakers index forward and begin mixing. They mix for as long as is required then they stop mixing, the contents settle, the solution is withdrawn from the beaker, pumped through filter paper that is arranged reel to reel, and then filled into test tube racks. Cleaning of the beakers is done with water, followed by, a deionized water rinse, cleaning of the filter lines is done with the first flush of product.

This filtration aspect of this invention is superficially similar in principle to U.S. Pat. No. 4,568,520 (Apparatus of the automated production of a series of samples for the analysis of mixtures) in which the filter medium is supplied using a roll. However this invention has a completely different purpose in that we are analysing the filtrate, they are analysing the filtercake. In addition the mechanism and process in our system is different, as examples:

a different drive system (reel to reel as opposed to drive rollers),

a guidance system is not required,

the filter medium is paper, not fiber glass,

the filter paper is not cleaned

the filter paper is not stamped—it is wound onto a reel and discarded

the filter paper is able to process multiple streams

This invention is superficially similar in principle to U.S. Pat. No. 5,320,753 (Continuous Filter) in that the filter medium uses a reel to reel configuration. However this invention is for continuous filtration, our invention operates in a batch mode, i.e the filter paper must be stationary in our device when filtering is occurring, the continuous filter can filter continuously.

This invention is superficially similar in principle to U.S. Pat. No. 5,734,114 (Nozzle apparatus for sampling and dispensing specimen) in that it uses an inflatable seal to connect to tubes and allow passage of material through the seal. However our invention differs in a number of ways including:

the material drops through the annulus by gravity, it is not pumped or sucked
the seal is not required for joining two tubes, it only seals one item—the container,
the material is powder, not fluid (specifically blood) as described in this invention.

This invention is superficially similar in principle to Internation Publication Number WO 2004/041435 A2. However the method of our invention is completely different as examples:

this system requires a packed bed of powder, our powder is held loosley in containers
we don't insert a tube
we don't produce a plug of powder.

### BRIEF DESCRIPTION OF THE DRAWINGS

FIG. 1 shows an elevation of an exemplary embodiment of the invention, illustrating how the various parts of the invention are linked.

FIG. 2 shows the operation of the filter.

FIG. 3 shows the disengaging and reengaging of agitation.

FIG. 4 shows the withdrawal of the chemical solution.

FIGS. 5a and 5b show the embodiment of the infeed head.

### DETAILED DESCRIPTION OF THE INVENTION

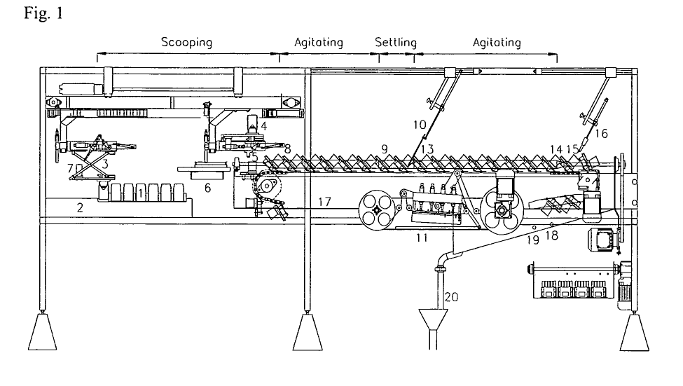

The invention comprises both a method and apparatus for automating routine laboratory operations required for analysing chemical properties of dried, pulverized earth. The current embodyment of the invention is shown in FIG. 1, the functions that it currently performs are as described as follows. Open topped containers (1) are manually placed on an infeed table (2) they are picked up by the infeed head (3), moved to filling positions (4), volumetrically dosing vessels such as beakers (5) or scales (6) or other vessels such as crucibles (not shown) To ensure an accurate and repeatible volume of powder is dispensed a vibrator (7) fluidizes the powder and compacts it. The beakers index forward, are dosed with a chemical solution (8) and engage with the agitation system. After a time the beakers disengage from the agitation system (9), the contents settle, a withdrawal tube is inserted into the beaker (10), the chemical solution is withdrawn and pumped through the filter (11) to the test tube racks (12). The beakers meanwhile re-engage with the agitation system (13) continue to agitate until they disengage complety from the agitation system (14), the contents settle (15) and pH is measured (16). The beakers return to the fill point (5) via the return strand of the conveyor (17) and on the way they are washed (18) then rinsed (19) with deionized water. The drain (20) discharges to waste.

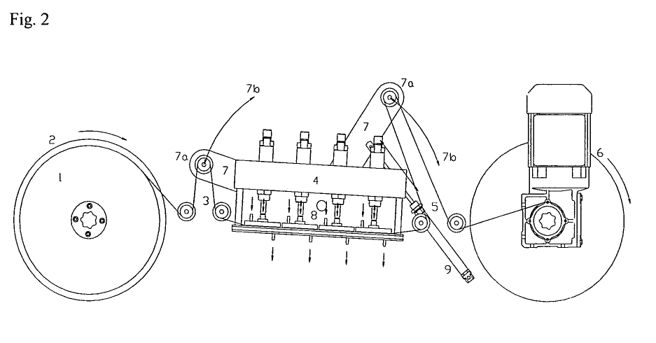

The apparatus comprises a filtration system of which the current embodiment is shown in FIG. 2. The filter medium (1) in this case paper, is stored on a powered reel (2). the paper is runs past infeed rollers (3) through the filter press (4), through the outfeed rollers (5) and onto a powered out feed reel (6) Connecting the outfeed and infeed rollers is a quick change arm (7). The quick change arm has two positions—one is shown, (7a) the other is indicated by rotational arrows (7b). To change position the quick change arm has a pivot (8) and is contolled in this case by a cylinder (9). When the arm is preloaded. (7b) there is sufficient paper accumulated around the infeed rolls (3) so that when the filter press (4) is disengaged the quick change arm moves to position 7a and the used filter paper is exchanged with clean filter paper. This allows for rapid exchange of paper. Once the filter press (4) has closed the powered reel winds up the spent paper and preload the quick chage arm back to the preload position (7b) In this way filter paper can be rapidly changed without breaking the paper.

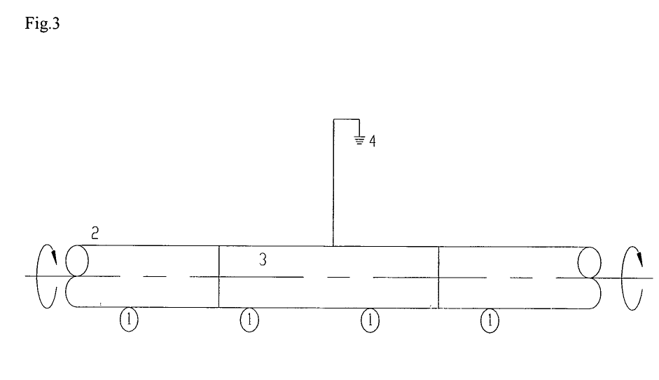

FIG. 3 shows the embodiment of the agitation system. The beakers are agitated by being inclined and turned by cords that run around a pulley located at the base of each beaker. (not shown) The cords (1) contact with a rotating shaft (2). This drives the cords which then turn the beakers. When the cords are driven onto a stationary sleeve (3) which is anchored (4) the cords stop turning. When the cords leave the sleeve they reengage with the shaft and the cords restart turning the beakers. In this way the beakers can agitate, settle, and then reagitate.

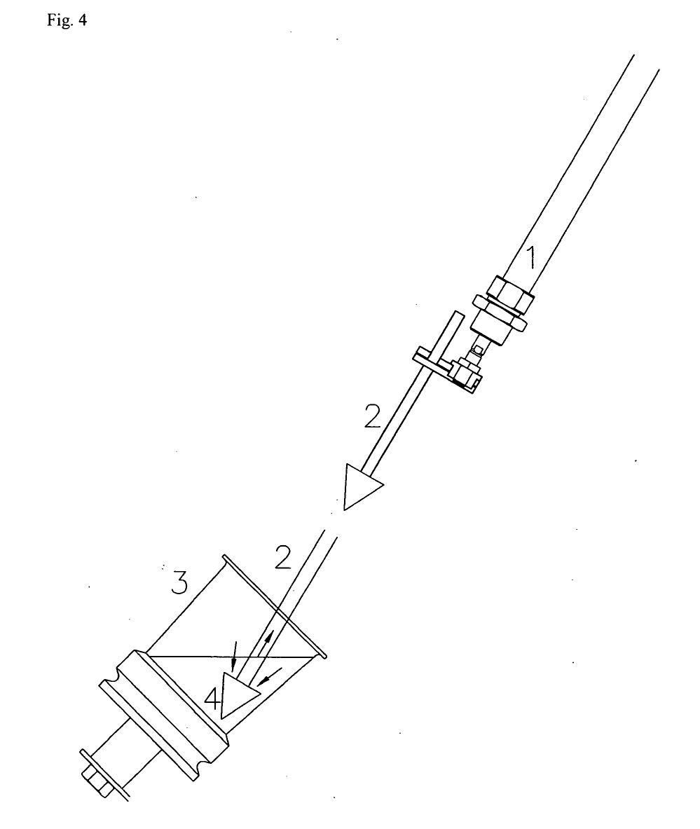

FIG. 4 shows the embodiment of the chemical solution withdrawal system. A cylinder (1) extends pushing the withdrawal tube (2) into a beaker (3). The tip of the withdrawal tube (4) is blind but has ports in the top surface. This allows liquid to be drawn from the top surface and minimises sediment being withdrawn from the beaker.

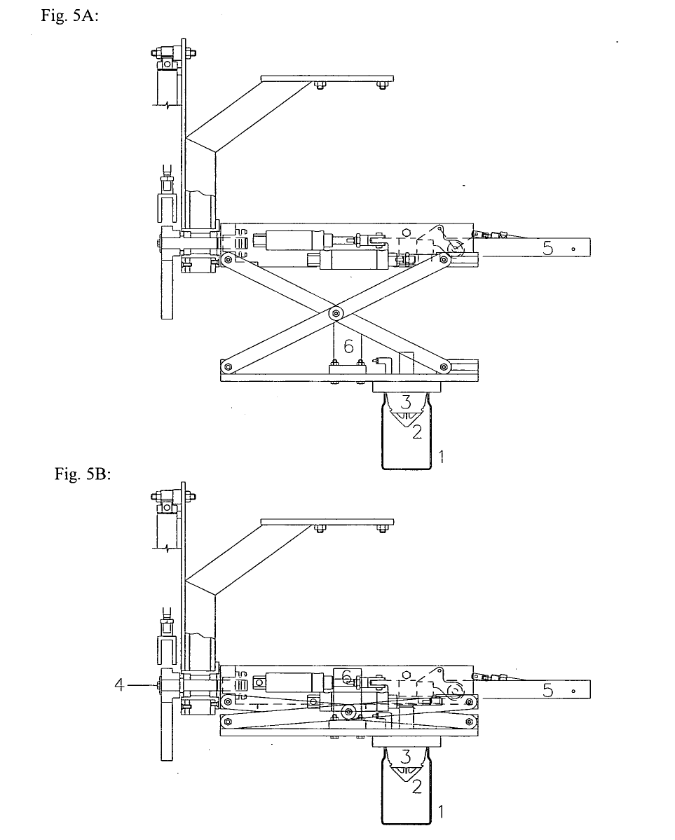

FIGS. 5a and 5b show the embodiment of the infeed head. The head is moved on x and y drives (not shown) and when in position lowers onto a container (1). Final alignment is assisted by guides (2). when in position an elastic ring (3) inflates inside the neck and the container is lifted (FIG. 5b). The head rotates along an axis (4) allowing the powder inside the container (1) to fall through the inflated ring (2) into a cavity contained in a sliding block (5). a vibrator (6) activates, this ensures that fine powder flow and compact into the cavity. The sliding block extends and the powder falls from the cavity by gravity.

What is claimed is:

1. A method to filter one or more samples simultaneously using filter paper supplied from a reel, and a quick change device to rapidly replace the paper.

2. The filter mechanism is cleaned using only air and the first portion of the following filtrate, which is discharged to drain.

3. A method for stopping the agitation of beakers, allowing the contents to settle.

4. A method for withdrawing reagent from the top surface of the liquid.

5. A method for dispensing powder from open topped containers into beakers.
